(19) United States
(12) Patent Application Publication
(10) Pub. No.: US 2003/0018721 A1
(43) Pub. Date: Jan. 23, 2003

(54) Unified messaging with separate media component storage

(76) Inventors: Virad Gupta, Fremont, CA (US); Shital Mehta, Sunnyvale, CA (US); David Israel, Santa Clara, CA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 09/893,742

(22) Filed: Jun. 29, 2001

(51) Int. Cl. G06F 15/16

(52) U.S. Cl. 709/206; 709/203; 709/219

(57) ABSTRACT

The present invention relates to a system, method and computer program product for providing unified messaging using separate storage of media components. The present invention allows for more efficient storage and retrieval of messages. Consider a message sent from a second user to a first user over a network. The message is received by a first server. The first server stores the media component of the message on a mass storage device. The first server also stores on an email server a header, including information about the message, and a reference to the corresponding media component of the message stored on the mass storage device. Upon retrieval of a stored message by the first user, the email server is queried via the first server. Subsequently, the email server provides to the first user, via the first server: the header, or non-media component of the message, and the reference to the corresponding media component of the message stored on the mass storage device. The reference can then used by the first user to retrieve from the mass storage device the corresponding media component of the message. Subsequently, the first user can view the entire message.

### BACKGROUND OF THE INVENTION

1. Field of the Invention

The present invention relates to unified messaging.

2. Background Art

Transmitting and receiving various messages (also called “messaging”) has become increasingly important in a variety of environments. Messaging is carried out and relied upon by an increasing number of users in the home, office and other locations. These messages include electronic messages (“email”), voice messages (“voice mail”) and faxes. Users increasingly rely on different types of devices such as email clients, fax clients and telephone clients to create and retrieve different types of messages. Typically, an office uses separate servers (separate email servers and voice mail servers) for handling email, voice mail and faxes independently. As such, an office worker is required to check various devices—a computer, a telephone and a fax machine—in order to receive all of his messages. This is time consuming, confusing and can lead to lost or duplicated messages.

Unified messaging solves this problem by providing a central location for receiving and processing messages. Using unified messaging, a user can check all of his or her messages at one location with one client device.

One approach to unified messaging involves the storage of all messages on an email server. A user may then receive all of his or her messages from the email server through a telephone or computer. This technique, however, has its drawbacks. Upon storage of a message having a large media component, such as a voice mail, significant time and storage resources are consumed. In addition, messages are often saved in a MIME format on an email server. This can be a problem when storing a message having a large media component. MIME format files require a considerable amount of resources to encode and decode. This leads to delays, or latency, when messages are stored or retrieved.

Latency is undesirable when a real-time device is used to retrieve messages. For example, when a telephone is used to retrieve voice mail messages, most users are not accustomed to experiencing a delay when retrieving a message. For this reason, retrieval times for voice mail messages need to be very short—on the order of a few seconds or less. A unified messaging system that stores voice mail and email messages in an integrated fashion on a email server often cannot deliver a message containing a large media component quickly. Some amounts of latency is allowed when a non-real-time device, such as a computer email client, is used to retrieve messages.

These limitations are even more acute when the unified messaging system needs to accommodate a large number of real-time accesses. A unified messaging system that stores all messages on an email server cannot scale effectively to accommodate a large number of users demanding access to media via real-time devices such as telephones.

Another approach to unified messaging involves the dual storage of messages on an email server and on a mass storage device. This embodiment seeks to solve the latency problem with the use of the mass storage device. Storage and retrieval times of large media files are reduced when using a mass storage device as opposed to an email server. Thus, using the dual storage technique, a non-real-time device can retrieve messages from the email server, while a real-time device can retrieve messages from the mass storage device in order to save time. This technique, however, has the disadvantage of consuming significant storage and processing resources due to the dual storage of all messages.

In view of the above, what is needed is a unified messaging solution that handles messages more efficiently. What is needed is a unified messaging solution where storage and retrieval times of messages are minimized. A unified messaging solution which can scale to accommodate a large number of real-time accesses to media is needed.

### BRIEF SUMMARY OF THE INVENTION

The present invention relates to a system, method and computer program product for providing unified messaging using separate storage of media components. The present invention allows for more efficient storage and retrieval of messages. Unified messaging using separate storage of media components according to the present invention can scale to support a large number of acceses by real-time devices.

Consider a voice mail or a fax message sent from a second user to a first user over a network. In the present invention, the message is received by a voice mail server. The voice mail server stores the message on a mass storage device. The voice mail server also stores a header, including information about the message, as well as a reference to the corresponding media component of the message stored on the mass storage device, on the email server.

Alternatively, consider an email message, including a media component, sent from a second user to a first user over a network. In the present invention, the message is received by the voice mail server. The voice mail server stores the media component of the message on a mass storage device. The voice mail server also stores the non-media component of the message, as well as a reference to the corresponding media component of the message stored on the mass storage device, on an email server.

Upon retrieval of a stored message by the first user, the email server is queried. Subsequently, the email server provides to the first user: the header, or non-media component of the message, and the reference to the corresponding media component of the message stored on the mass storage device. The reference can then be used by the first user to retrieve from the mass storage device the corresponding media component of the message. Subsequently, the first user can view the entire message.

One advantage of the present invention is the reduction in storage and retrieval times when saving and retrieving messages. The use of a mass storage device to store the media component of a message streamlines the storage and retrieval process.

### BRIEF DESCRIPTION OF THE FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram illustrating the system architecture of a unified messaging system in an embodiment of the present invention.

FIG. 2 is a block diagram illustrating the architecture of a proxy server in an embodiment of the present invention.

FIG. 3 is a flowchart depicting an embodiment of the operation and control flow of the voice mail or fax message storage process in an embodiment of the present invention.

FIG. 4 is a block diagram illustrating the architecture of a voice mail server, showing connectivity between elements, in an embodiment of the present invention.

FIG. 5 is a flowchart depicting an embodiment of the operation and control flow of the email message storage process in an embodiment of the present invention.

FIG. 6A is a flowchart depicting an embodiment of the operation and control flow of the message retrieval process using a non-real-time device, in an embodiment of the present invention.

FIG. 6B is a flowchart depicting an embodiment of the operation and control flow of the message retrieval process using a real-time device, in an embodiment of the present invention.

FIG. 7A is a diagram depicting the sequence of events during the message retrieval process using a non-real-time device, as shown in FIG. 6, in an embodiment of the present invention.

FIG. 7B is a diagram depicting the sequence of events during the message retrieval process using a real-time device, as shown in FIG. 6, in an embodiment of the present invention.

FIG. 8 is an example computer system and computer program product that can be used to implement the present invention.

### DETAILED DESCRIPTION OF THE INVENTION

### Table of Contents

I. Overview

II. System Architecture

III. Messaging Process

A. Voice Mail and Fax Message Storage

B. Email Message Storage

C. Message Retrieval with Non-Real-Time Device

D. Message Retrieval with Real-Time Device

IV. System Control

V. Conclusion

I. Overview

The present invention relates to a system, method and computer program product for providing unified messaging using separate storage of media components. The present invention allows for more efficient storage and retrieval of messages.

The present invention is described in terms of the examples contained herein. This is for convenience only and is not intended to limit the application of the present invention. In fact, after reading the following description, it will be apparent to one skilled in the relevant art(s) how to implement the following invention in alternative embodiments.

The term “message” refers to any type of message including, but not limited to, electronic messages (“email”), voice message (“voice mail”) and faxes.

The term “media component” includes, but is not limited to, voice data and fax data. “Audio data” can include digital data representing any type of audio, such as voice, speech, music, and/or sound.

The term “client” refers to any network device that can handle messages with a media component. A client can include a telephone client or email client. A client can be implemented on a telephone, computer, personal data assistant (PDA), palm device, set-top box, television, processor or other type of network device.

II. System Architecture

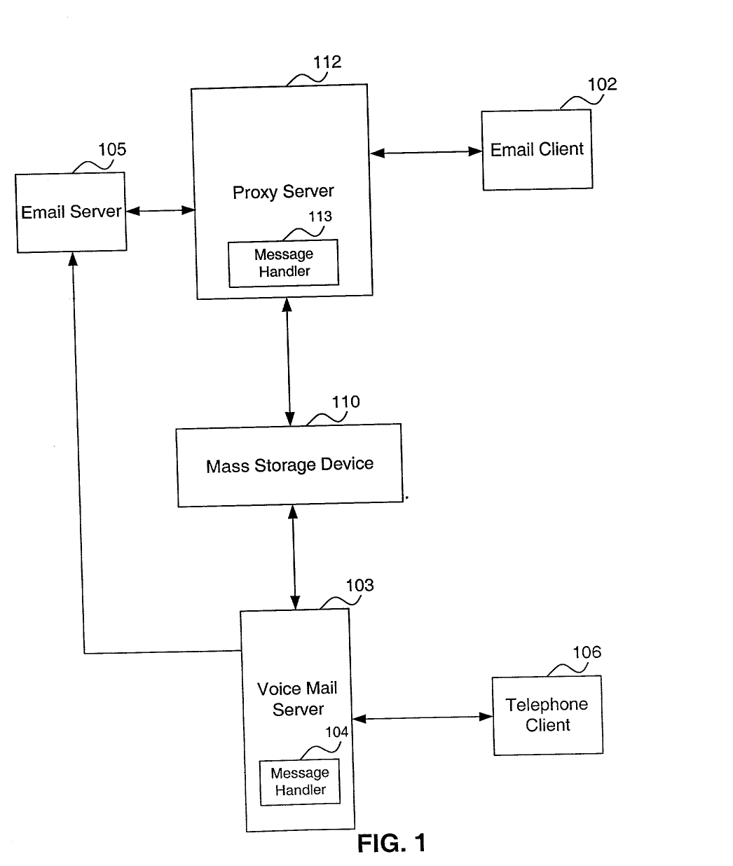

FIG. 1 shows a block diagram illustrating the system architecture 100 of a unified messaging system, in an embodiment of the present invention. System 100 includes an email server 105, a proxy server 112, a mass storage device 110 and a voice mail server 103. In addition, proxy server 112 includes message handler 113 and voice mail server 103 includes message handler 104. The users of system 100 include email client 102 and telephone client 106. Although only two clients of system 100 are shown (email client 102 and telephone client 106), system 100 can support various numbers of email and telephone clients.

The term “server” is used broadly to refer to a computer, and its corresponding software, that is dedicated to managing a particular network resource. For example, a file server is dedicated to storing files and an email server is dedicated to managing email functions.

Email server 105 can be any standard email server that is known in the art.

An example of such a standard email server is a computer including the Microsoft Exchange Server software, available from Microsoft Corp. of Redmond, Wash. Email server 105 possesses a means for storing data. For example, email server 105 can include a storage device similar to mass storage device 110 described below.

Proxy server 112 performs many of the functions of a standard proxy server known in the art. An example of such a standard proxy server is a computer including the Microsoft Proxy Server software, available from Microsoft Corp. of Redmond, Wash. Proxy server 112, however, also includes message handler 113 which includes additional logic for retrieving messages. Message handler 113 can be implemented in software or hardware form. The functions performed by message handler 113 are described in greater detail below.

Voice mail server 103 performs many of the functions of a voice mail server known in the art. A voice mail server is a server dedicated to handling voice mail functions. In an embodiment of the present invention, voice mail server 103 is dedicated to managing voice mail and fax messages.

Mass storage device 110 can be any type of storage device that can store and retrieve media components quickly. In one example, mass storage device 110 is a standard hard drive capable of storing and retrieving considerable quantities of data. An example of such a device is the F820c Enterprise Filer 12 TB storage appliance available from Network Appliance Corp. of Sunnyvale Calif.

Email client 102 can be a person and a computer that is a client of email server 105 and proxy server 112. Email client 102 subscribes to the email functions of email server 105 via proxy server 112. Email client 102 may utilize any of a number of communications protocols. For example, the following specific communications protocols can be supported: IMAP, POP and HTTP. The IMAP, POP and HTTP protocols can be utilized by a client using a home computer to connect to proxy server 112. Support for the various communications protocols is explained in greater detail below.

Telephone client 106 can be a person and a telephone. Telephone client 106 interacts with voice mail server 103 which serves voice mail functions to telephone client 106.

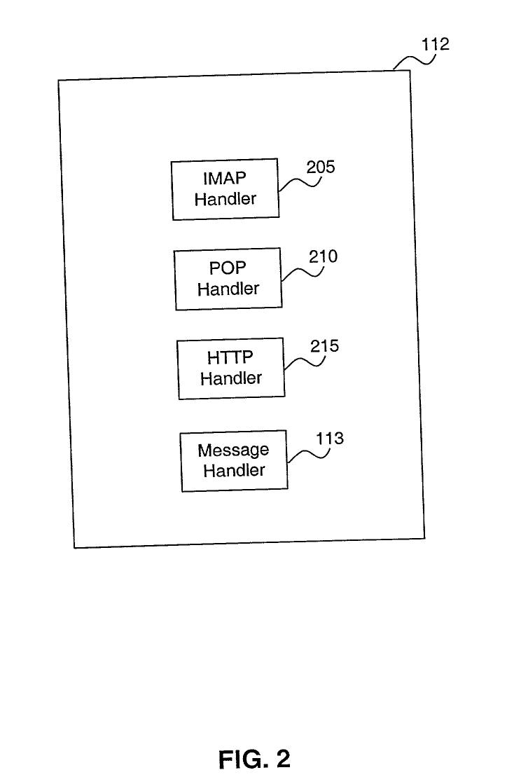

FIG. 2 shows a block diagram illustrating the architecture 200 of proxy server 112, in an embodiment of the present invention. Proxy server 112 comprises a number of communication protocol modules 205, 210 and 215. In this example, three specific communications protocols are supported. Accordingly, proxy server 112 comprises three support modules: an IMAP handler 205, a POP handler 210 and an HTTP handler 215. In this fashion, proxy server 112 is generalized and can handle multiple communications protocols. Accordingly, in the example, the IMAP handler 205 accepts IMAP requests from email client 102. Similarly, the POP handler 210 accepts POP requests from email client 102 and the HTTP handler 215 accepts HTTP communications requests from email client 102. In this fashion, each email client 102 communicates with proxy server 112 in their native protocol. This has the advantage of allowing conventional software to be used within each client with little or no modification. In other words, the proxy server 112 of the present invention is transparent to the clients.

III. Messaging Process

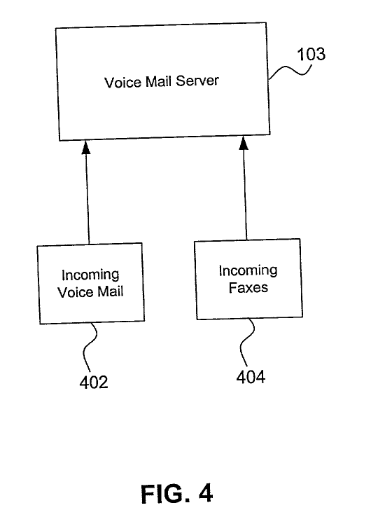

FIG. 4 shows a block diagram illustrating the architecture 400 of voice mail server 103, showing connectivity between elements, in an embodiment of the present invention. Voice mail server 103 handles incoming messages of various types. In an embodiment of the present invention, voice mail server 103 handles incoming voice mail messages 402 and incoming fax messages 404. In another embodiment of the present invention, voice mail server 103 can handle other messages known to one of ordinary skill in the art.

A. Voice Mail and Fax Message Storage

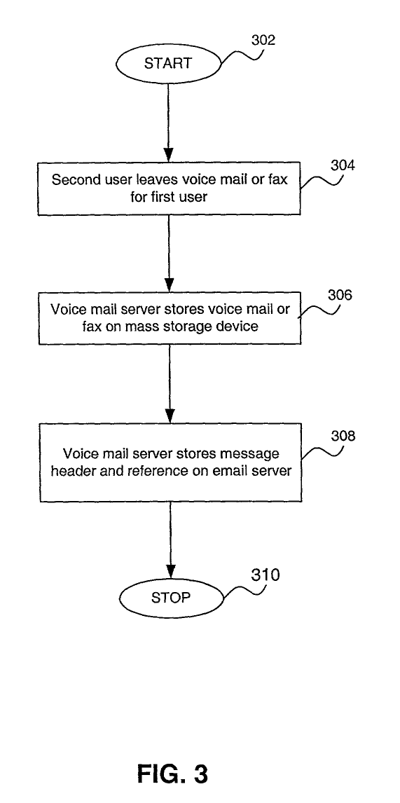

FIG. 3 shows a flowchart depicting an embodiment of the operation and control flow 300 of the voice mail and fax message storage process of the present invention. Flow 300 is an example of how a voice mail or fax message can be stored using the system and method of the present invention. Control flow 300 begins with step 302 and proceeds immediately to step 304.

In step 304, a second user leaves a voice mail or fax message for a first user, i.e., email client 102 or telephone client 106. In the case where the second user leaves a voice mail message, the second user can be similar to telephone client 106. In step 304, typically, the second user utilizes a device such as a telephone or fax machine to communicate with the first user. Subsequently, the second user is directed to voice mail server 103. Using the functions of voice mail server 103 and message handler 104, the second user leaves a voice mail or fax message for the first user.

In step 306, voice mail server 103, using the logic of message handler 104, stores the message left by the second user on mass storage device 110. The stored file is indexed such that the intended recipient of the audio message, the first user, can retrieve it. In an embodiment of the present invention, voice mail server 103 stores a voice mail message using a WAV audio file format. In another embodiment of the present invention, voice mail server 103 stores a voice mail message using any standard audio file format known in the art. The file stored on mass storage device 110 is referred to as the media portion of the message.

In step 308, voice mail server 103, using the logic of message handler 104, stores a message header on email server 105. The message header includes basic information about the message left by the second user. The basic information included in the header can include the time the message was left, the type of message left and the size of the message. The basic information included in the header can also include any other information that may be garnered from the message by voice mail server 103. Together with the header, voice mail server 103, using the logic of message handler 104, also stores a reference to the media portion of the message stored on mass storage device 110 in step 306 above. This reference provides information as to where the media portion of the message is located on mass storage device 110 so that the first user is able to retrieve it.

In step 310, flow 300 ceases.

B. Email Message Storage

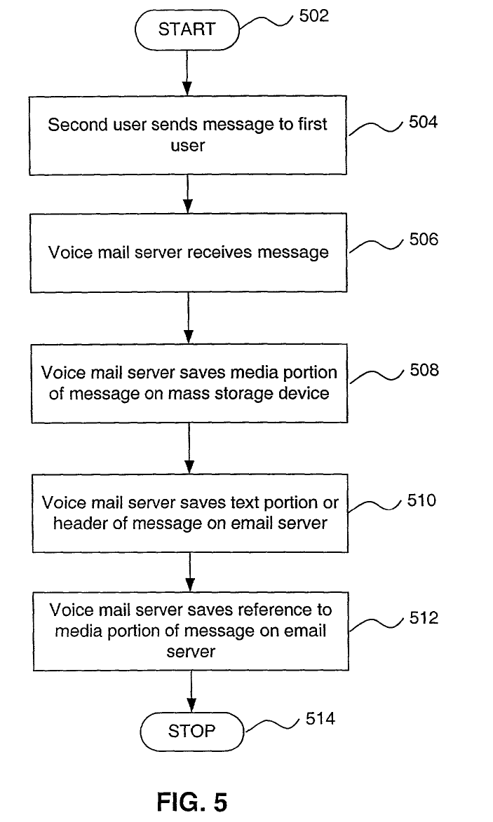

FIG. 5 shows a flowchart depicting an embodiment of the operation and control flow 500 of the email message storage process of the present invention. Flow 500 is an example of how an email message containing a media component can be stored using the system and method of the present invention. Control flow 500 begins with step 502 and proceeds immediately to step 504.

In step 504, a second user, similar to email client 102, sends an email containing a media component to a first user, i.e., email client 102 or telephone client 106. The media component of the email message can be a voice mail message or a fax message. The second user can send the email message to the first user via a network or combination of networks such as the Internet. Alternatively, if the second user is located within the same Local Area Network (LAN) as the first user, the second user can send the email message to the first user via the LAN.

In step 506, voice mail server 103 receives the email. In one embodiment of the present invention, the email message was received by voice mail server 103 via a firewall.

In step 508, voice mail server 103, using the logic of message handler 104, stores the media component of the email message on mass storage device 110. The stored file is indexed such that the intended recipient of the email message, the first user, can retrieve it. In an embodiment of the present invention, voice mail server 103 stores the audio media component using a WAV audio file format. In another embodiment of the present invention, voice mail server 103 stores the audio media component using any standard audio file format known in the art.

In step 510, voice mail server 103, using the logic of message handler 104, stores the text component of the email message on email server 105. In the case where there is no text component of the email message, a header including basic information about the email message is stored on email server 105.

In step 512, voice mail server 103, using the logic of message handler 104, stores on email server 105, together with the text component or the header stored in step 510, a reference to the stored media component of the email message. The reference provides information as to where the media portion of the email message is located on mass storage device 110 so that the first user is able to retrieve it. The reference is associated with the stored text component or header of the email such that when the email message is retrieved from email server 105, the reference to the media component, and not the media component itself, is displayed.

In an embodiment of the present invention, the reference can be a standard HTTP link. In other embodiments, the reference can be any identifier, name, descriptor or tag.

In step 514, flow 500 ceases.

It should be noted that, in an embodiment of the present invention, the process defined in flow 500 occurs only when the party sending the email message, the second user, is a client of the unified messaging system 100. That is, the process of separately storing the media component of an email message occurs only when the second user subscribes to unified messaging system 100. Thus, the process described in flow 500 would not execute if the second user utilizes an email client which does not subscribe to the services of unified messaging system 100—for example, a widely available internet email client such as Hotmail (available at http://www.hotmail.com).

A second user can subscribe to the services of unified messaging system 100 by using a client which interfaces with the unified messaging system 100. One example of such a client includes a web client. A web client which interfaces with the unified messaging system 100 includes a web site or web page which allows a user to enter information to send as an email. Another example of such a client is a Wireless Application Protocol (WAP) interface. A WAP interface which interfaces with the unified messaging system 100 includes an interface available via a wireless device which allows a user to enter information to send as an email.

C. Message Retrieval with Non-Real-Time Device

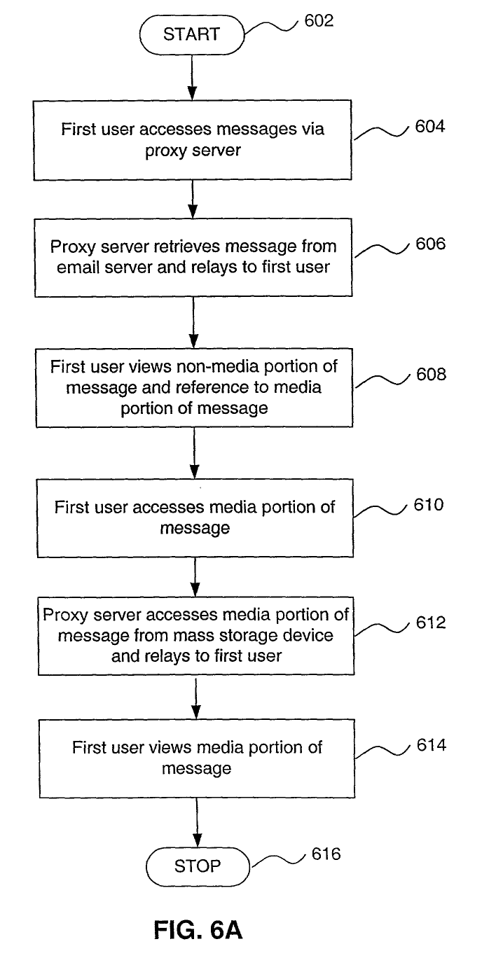

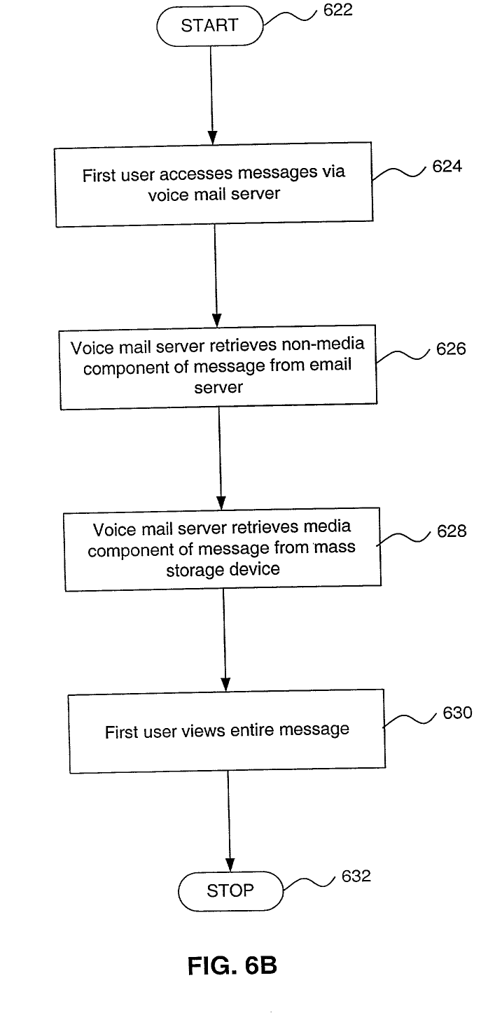

FIG. 6A shows a flowchart depicting an embodiment of the operation and control flow 600 of the message retrieval process using a non-real-time device, in an embodiment of the present invention. Flow 600 is an example of how a message can be retrieved with a non-real-time device using the system and method of the present invention. Control flow 600 begins with step 602 and proceeds immediately to step 604.

In step 604, the first user accesses email server 105 via proxy server 112. For the purposes of this example control flow, the first user shall be email client 102. Therefore, in this example, the first user is utilizing a standard computer email client to access his or her messages. However, flow 600A represents the message retrieval process using any non-real-time device known to one of ordinary skill in the art, such as a PDA, to access messages. In order to retrieve a message, email client 102 sends a request for a newly received message to proxy server 112, which then relays the request to email server 105.

In step 606, in response to the request from proxy server 112, email server 105 provides the stored non-media portion of the message, together with a reference to the media component of the message stored on mass storage device 110, to proxy server 112. Proxy server 112 then relays the information to email client 102. Note that the information provided to email client 102 is only a text portion or a header of a message, in addition to a reference. There is no media component of the message provided to email client 102 at this point.

In step 608, email client 102 views the non-media portion of the message, together with the reference to the media component of the message stored on mass storage device 110. The reference may be viewed as a link or some other item which may be activated by, for example, clicking on it.

In step 610, email client 102 requests the media component of the message by activating the reference provided. Email client 102 can issue this request automatically when a reference is detected or in response to a selection by the user. In doing so, email client 102 sends a request for the media component of the message to proxy server 112.

In step 612, in response to the request from email client 102, proxy server 112, using the logic of message handler 113, retrieves the media component of the message stored on mass storage device 110. Retrieval of the media component of the message from mass storage device 110 is relatively quick—on the order of a few seconds or less. Proxy server 112 then relays the media component to email client 102.

In an embodiment of the present invention, steps 606 and 612 occur simultaneously, while steps 608 and 610 do not occur. In this embodiment, proxy server 112 retrieves a message from email server 105 (this function is described in step 606). Then proxy server 112, using the logic of message handler 113, automatically determines that the message contains a reference to a media portion of the message stored on mass storage device 110, automatically retrieves the media portion of the message from mass storage device 110 and forwards it to email client 102 (this function is described in step 612). As such, the retrieval of the media portion of the message is seamless to email client 102.

In step 614, email client 102 views the entire message—the non-media component and the media component. For example, a user views complete messages, that is, email messages with media components and email messages containing actual voice of fax files. As used herein “view” refers broadly to the output of a media component to a user. This output may be seen, heard or experienced in other ways by the user.

In step 616, flow 600 ceases.

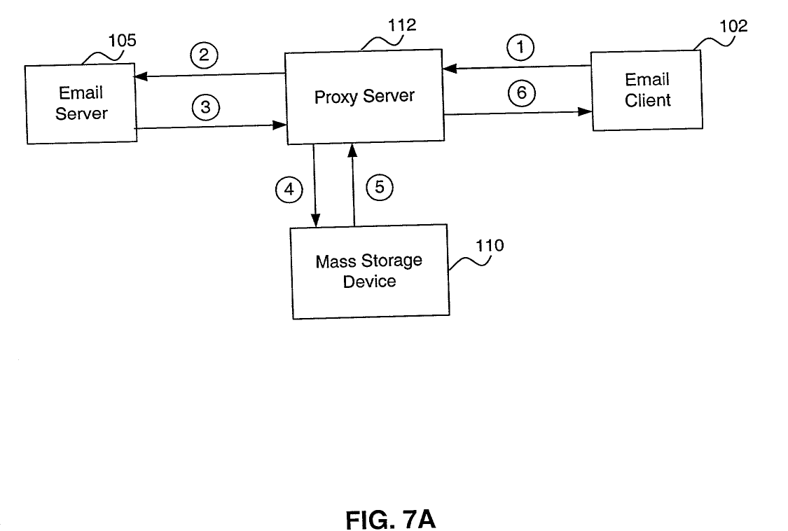

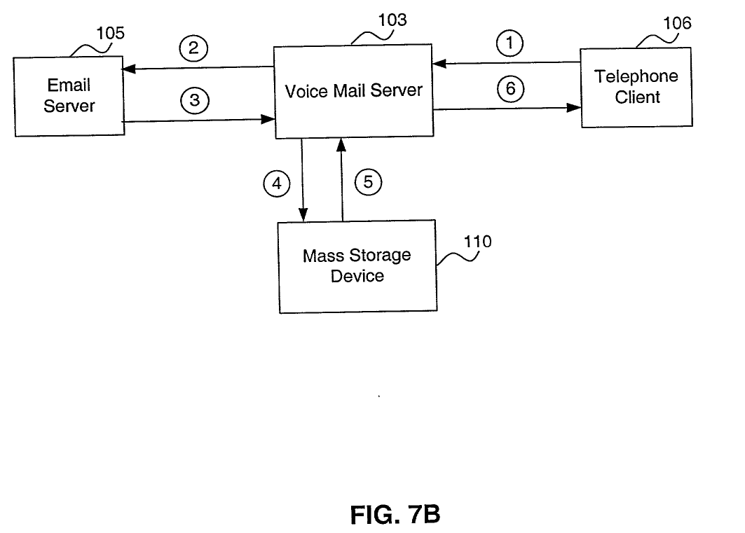

FIG. 7A shows a diagram depicting the sequence of events during the message retrieval process of the present invention, as shown in flow 600, in an embodiment of the present invention. Flow 600 is an example of how a message containing a media component can be retrieved with a non-real-time device using the system and method of the present invention.

Event 1 (see step 604, FIG. 6A) represents email client 102 requesting a message from email server 105, via proxy server 112.

Event 2 (see step 606) represents proxy server 112 requesting the message from email server 105.

Event 3 represents email server 105 providing the non-media portion of the message to proxy server 112.

Event 4 (see step 612) represents proxy server 112 requesting the media component of the message from mass storage device 110.

Event 5 represents mass storage device 110 providing the media component of the message to proxy server 112.

Event 6 represents proxy server 112 providing the entire message (non-media component and media component) to email client 102. At this point (see step 614), email client 102 may view the entire message.

D. Message Retrieval with Real-Time Device

FIG. 6B shows a flowchart depicting an embodiment of the operation and control flow 650 the message retrieval process using a real-time device, in an embodiment of the present invention. Flow 650 an example of how a message can be retrieved with a real-time device using the system and method of the present invention. Control flow 650 begins with step 622 and proceeds immediately to step 624.

In step 624, the first user accesses email server 105 via a voice mail server 103. For the purposes of this example control flow, the first user shall be telephone client 106. Therefore, in this example, the first user is utilizing a standard telephone to access his messages. However, flow 650 represents the message retrieval process using any real-time device known to one of ordinary skill in the art to access messages. In order to retrieve a message, telephone client 106 sends a request for a newly received message to voice mail server 103, which then relays the request to email server 105.

In step 626, in response to the request from voice mail server 103, email server 105 provides the stored non-media portion of the message, together with a reference to the media component of the message stored on mass storage device 110, to voice mail server 103. Note that the information provided to voice mail server 103 is only a text portion or a header of a message, in addition to a reference.

In step 628, voice mail server 103 determines that the message retrieved from email server 105 contains a reference to a media portion stored on mass storage device 110. Subsequently, voice mail server 103, using the logic of message handler 104, retrieves the media component of the message stored on mass storage device 110. Retrieval of the media component of the message from mass storage device 110 occurs at a real-time rate. Voice mail server 103 then relays the entire message (media component and non-media component) to telephone client 106 in real-time. In this way, the unified messaging system with mass storage of the present invention allows real-time delivery of large media components, on the order of a megabyte or grater, to real-time devices.

In step 630, telephone client 106 views the entire message—the non-media component and the media component. As used herein “view” refers broadly to the output of a media component to a user. This output may be seen, heard or experienced in other ways by the user.

In step 632, flow 650 ceases.

FIG. 7B shows a diagram depicting the sequence of events during the message retrieval process of the present invention, as shown in flow 650, in an embodiment of the present invention. Flow 650 is an example of how a message containing a media component can be retrieved with a real-time device using the system and method of the present invention.

Event 1 (see step 624, FIG. 6B) represents telephone client 106 requesting a new message from email server 105, via voice mail server 103.

Event 2 (see step 626) represents voice mail server 103 requesting the new message from email server 105.

Event 3 represents email server 105 providing the non-media portion of the new message to voice mail server 103.

Event 4 (see step 628) represents voice mail server 103 requesting the media component of the new message from mass storage device 110.

Event 5 represents mass storage device 110 providing the media component of the new message to voice mail server 103.

Event 6 represents voice mail server 103 providing the entire message (non-media component and media component) to telephone client 106. At this point (see step 630), telephone client 106 may view the entire message.

One advantage of flow 600 and flow 650 is the quick retrieval time of the media portion of the message from mass storage device 110. This advantage is realized when any device is used to access a message and its media component. However, this advantage is particularly beneficial when a real-time device, such as a telephone, is used to retrieve a message. Typically, users who retrieve messages using a real-time device are accustomed to quick retrieval of messages and do not tolerate latency or delays in retrieval. Conversely, users who retrieve messages using a non-real-time device, such as a computer, are accustomed to some latency or delay in retrieval.

Another advantage of flow 600 and flow 650 is the user of the WAV format file. The retrieval time of a WAV format file from mass storage device 110 is greatly reduced in comparison to the retrieval of a MIME format file. As such, latency and delay in retrieval is reduced.

IV. System Control

The functions performed by email server 105, proxy server 112, message handler 113, mass storage device 110, voice mail server 103 and message handler 104 are preferably implemented in software. Alternatively, the same may be implemented using firmware or hardware, or a combination of firmware, hardware and/or software.

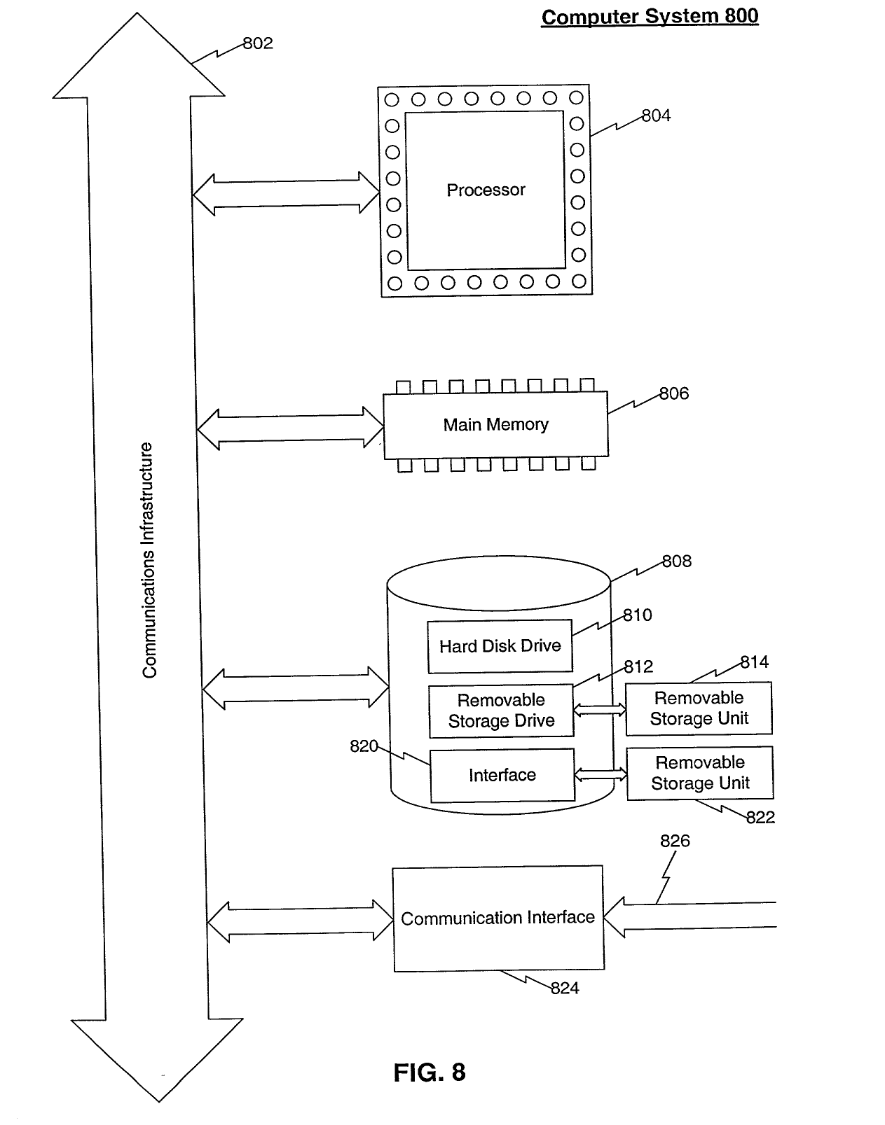

In an embodiment of the present invention, email server 105, email client 102, proxy server 112 (together with message handler 113), mass storage device 110 and voice mail server 103 (together with message handler 104) can each comprise a computer system which may be connected to a network. An example of such a computer system 800 is shown in FIG. 8. The computer system 800 represents any single or multi-processor computer. Single-threaded and multithreaded computers can be used. Unified or distributed memory systems can be used.

The computer system 800 includes one or more processors, such as processor 804. One or more processors 804 can execute software implementing the computer-based operations described in flow 300, flow 500, flow 600 and flow 650. Each processor 804 is connected to a communication bus 802 (e.g., cross-bar or network). Various software embodiments are described in terms of this exemplary computer system. After reading this description, it will become apparent to a person skilled in the relevant art how to implement the invention using other computer systems and/or computer architectures.

Computer system 800 also includes a main memory 806, preferably random access memory (RAM), and can also include a secondary memory 808. The secondary memory 808 can include, for example, a hard disk drive 810 and/or a removable storage drive 812, representing a floppy disk drive, a magnetic tape drive, an optical disk drive, etc. The removable storage drive 812 reads from and/or writes to a removable storage unit 814 in a well known manner. Removable storage unit 814 represents a floppy disk, magnetic tape, optical disk, etc., which is read by and written to by removable storage drive 812. As will be appreciated, the removable storage unit 814 includes a computer usable storage medium having stored therein computer software and/or data.

In alternative embodiments, secondary memory 808 can include other means for allowing computer programs or other instructions to be loaded into computer system 800. Such means can include, for example, a removable storage unit 822 and an interface 820. Examples can include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 can also include a communications interface 824. Communications interface 824 allows software and data to be transferred between computer system 800 and external devices via communications path 826. Examples of communications interface 820 can include a modem, a network interface (such as Ethernet card), a communications port, etc. Software and data transferred via communications interface 824 are in the form of signals which can be electronic, electromagnetic, optical or other signals capable of being received by communications interface 824, via communications path 826. Note that communications interface 824 provides a means by which computer system 800 can interface to a network such as the Internet.

The present invention can be implemented using software running (that is, executing) in an environment similar to that described above with respect to FIG. 8. In this document, the term “computer program product” is used to generally refer to removable storage unit 814, a hard disk installed in hard disk drive 810, or a carrier wave carrying software over a communication path 826 (wireless link or cable) to communication interface 824. A computer useable medium can include magnetic media, optical media, or other recordable media, or media that transmits a carrier wave. These computer program products are means for providing software to computer system 800.

Computer programs (also called computer control logic) are stored in main memory 806 and/or secondary memory 808. Computer programs can also be received via communications interface 824. Such computer programs, when executed, enable the computer system 800 to perform the features of the present invention as discussed herein. In particular, the computer programs, when executed, enable the processor 804 to perform the features of the present invention. Accordingly, such computer programs represent controllers of the computer system 800.

In an embodiment where the invention is implemented using software, the software can be stored in a computer program product and loaded into computer system 800 using removable storage drive 812, hard drive 810, or communications interface 824. Alternatively, the computer program product can be downloaded to computer system 800 over communications path 824. The control logic (software), when executed by the one or more processors 804, causes the processor(s) 804 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s).

V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus the present invention should not be limited by any of the above-described exemplary embodiments, but should be defined only in accordance with the following claims and their equivalents.

What is claimed is:

1. A method for providing unified messaging to a first user, comprising the steps of:
(1) receiving a message from a second user to the first user, wherein said message comprises a media component and a non-media component;
(2) storing on a mass storage device said media component of said message; and
(3) storing on an email server said non-media component of said message and a corresponding reference to said stored media component of said message.

2. The method of claim 1, further comprising the steps of:
(4) receiving from the first user a request for said message;
(5) retrieving from said email server said non-media component of said message and said corresponding reference; and
(6) providing to the first user said non-media component of said message and said corresponding reference.

3. The method of claim 2, further comprising the step of:
(7) receiving from the first user a request for said stored media component of said message, wherein said request is received via said corresponding reference;
(8) retrieving from said mass storage device said stored media component; and
(9) providing to the first user said stored media component.

4. The method of claim 3, wherein said message is any one of: a voice mail message, a fax message and an email message.

5. The method of claim 1, further comprising the steps of:
(4) receiving from the first user a request for said message;
(5) retrieving from said email server said non-media component of said message and said corresponding reference;
(6) retrieving from said mass storage device said stored media component, wherein said retrieving is performed using said corresponding reference; and
(7) providing to the first user said stored media component of said message and said non-media component of said message.

6. The method of claim 5, wherein said message is any one of: a voice mail message, a fax message and an email message.

7. A system for providing unified messaging to a first user, comprising:
a mass storage device for storing the media component of a message;
a storage device, coupled to an email server, that stores the non-media component of said message and a corresponding reference to the media component of said message;
a voice mail server that receives said message from a second user to the first user, wherein said message includes a media component and a non-media component; and
a message handler, coupled to said voice mail server, that sends to said mass storage device the media component of said message for storage and that sends to said storage device the non-media component of said message for storage.

8. The system of claim 7, wherein said message is any one of: a voice mail message, a fax message and an email message.

9. A computer program product comprising a computer useable medium having control logic stored therein for causing a computer to provide unified messaging to a first user, the computer control logic comprising:
first computer readable program code means for causing the computer to receive a message from a second user to the first user, wherein said message comprises a media component and a non-media component;
second computer readable program code means for causing the computer to store on a mass storage device said media component of said message; and
third computer readable program code means for causing the computer to store on an email server said non-media component of said message and a corresponding reference to said stored media component of said message.

10. The computer program product of claim 9, the computer control logic further comprising:
fourth computer readable program code means for causing the computer to receive from the first user a request for said message;
fifth computer readable program code means for causing the computer to retrieve from said email server said non-media component of said message and said corresponding reference; and
sixth computer readable program code means for causing the computer to provide to the first user said non-media component of said message and said corresponding reference.

11. The computer program product of claim 10, the computer control logic further comprising:
seventh computer readable program code means for causing the computer to receive from the first user a request for said stored media component of said message, wherein said request is received via said corresponding reference;
eighth computer readable program code means for causing the computer to retrieve from said mass storage device said stored media component; and
ninth computer readable program code means for causing the computer to provide to the first user said stored media component.

12. The method of claim 11, wherein said message is any one of: a voice mail message, a fax message and an email message.

13. The computer program product of claim 9, the computer control logic further comprising:
fourth computer readable program code means for causing the computer receive from the first user a request for said message;
fifth computer readable program code means for causing the computer to retrieve from said email server said non-media component of said message and said corresponding reference;
sixth computer readable program code means for causing the computer to retrieve from said mass storage device said stored media component, wherein said retrieving is performed using said corresponding reference; and
seventh computer readable program code means for causing the computer to provide to the first user said stored media component of said message and said non-media component of said message.

14. The computer program product of claim 13, wherein said message is any one of: a voice mail message, a fax message and an email message.

15. A method for providing unified messaging for messages, comprising the step of:
storing media components of the messages at a first location: and
storing references to the stored media components of the messages and remaining portions of the messages without the media components at a second location, whereby the stored media components can be delivered in real-time to a real-time device.

16. A unified messaging system, comprising:
a first storage device that stores media components of messages; and
a second storage device that stores references to the stored media components of the messages and remaining portions of the messages without the media components.

17. The unified messaging system of claim 16, wherein said first storage device comprises a mass storage device, and said second storage device comprises an email server.
